(19) United States
(12) Patent Application Publication
(10) Pub. No.: US 2008/0243551 A1
(43) Pub. Date: Oct. 2, 2008

(54) APPARATUS, SYSTEMS, AND METHODS FOR SECURE DISEASE DIAGNOSIS AND CONDUCTING RESEARCH UTILIZING A PORTABLE GENOMIC MEDICAL RECORD

(76) Inventor: Sundar Subramaniam, Cambridge, MA (US)

Correspondence Address: GOODWIN PROCTER LLP;PATENT ADMINISTRATOR, EXCHANGE PLACE, BOSTON, MA, 02109-2881, US

(21) Appl. No.: 11/752,530

(22) Filed: May 23, 2007

Related U.S. Application Data
(60) Provisional application No. 60/908,296, filed on Mar. 27, 2007.

(51) Int. Cl. G06F 19/00

(52) U.S. Cl. 705/3

(57) ABSTRACT

An electronic medical record system, method, and service is disclosed for storing patients genomic and medical information on portable storage devices to be used for private disease diagnosis and for patient-controlled participation in research queries. Using a computer with network access, patients conduct private disease diagnosis and disease forecasting by downloading genetic queries and running the queries against private genomic data stored on the portable storage device. To conduct patient-controlled research, patients are provided the capability of joining a peer-to-peer network and choice in deciding whether to participate in queries submitted by researchers over the network to patient network members. When patient network members decide to participate in a submitted query, they download the query, run the query against their private data, and anonymously submit the results back to the network.

### FIELD OF THE INVENTION

This invention is generally related to electronic medical records systems. More specifically, this present invention relates to the collection, storage, and processing of private genetic and medical information, utilizing various systems, including portable data storage devices to store personal data, downloading research queries using a computer with network access, running queries against the personal data on a computer, and providing patients the opportunity to anonymously share query results over a peer-to-peer network. The invention may be used for secure private testing to discover whether individuals have inherited genomic variations that cause or increase the risk of developing disease, and may be utilized to conduct research while maintaining the privacy of each individual and their data.

### BACKGROUND

### Prior Art

Governments, corporations, universities, and other institutions, are increasing interested in utilizing genetic information and electronic medical records in order to perform research into the causes of disease and to search for cures. Simultaneously, individuals are increasingly concerned about maintaining the privacy and security of their personal medical and genetic information. One of the most significant challenges facing the adoption of electronic medical records and integrating personal genetic information in such systems is the difficulty of keeping these records private. The task becomes even more complex with the additional desire of wanting to provide access to personal data in order to conduct research.

This dilemma is becoming more problematic as the cost of genomic testing and sequencing falls and as creating genomic records for individuals becomes more widely available. Many individuals are interested in learning whether they have inherited specific diseases but are legitimately concerned and especially vulnerable to discrimination if, for example, employers and insurers were to receive their private genomic information. Accordingly, as recognized by the inventor, there is a need for an apparatus, system, and method for the secure acquisition, storage, and utilization of personal genetic and medical information. The method described herein provides a unique solution to the conflict between privacy and the desire to use personal genomic and medical information in order to conduct research, perform medical evaluations, and to make personal health, lifestyle, and other important personal decisions based on one's own private genomic information.

While technology has been developed to provide the capability of storing medical records electronically, the utilization of electronic medical records and the sharing of this data for research purposes has not been as widespread as hoped due to the numerous obstacles faced in ensuring the privacy of data and the understandable reluctance of patients to share their data. Therefore, it would be an important advancement in the state of the art to provide an apparatus, system, and method for the collection, storage, and utilization of personal genomic and medical information for performing queries to diagnose disease and conduct research. It is against this background that the various embodiments of the present invention were developed.

Originally, medical records were stored utilizing paper record keeping systems, and often still are. While, electronic medical record systems have been developed by numerous companies and adopted by various institutions, the problem remains that current medical information collection, storage, and sharing methods have many inherent problems that make their utilization and adoption problematic. In addition, because new genomic tests that can predict the susceptibility of individuals to future disease are continually being developed, there is an even greater risk of discrimination to individual patients if their personal genomic and medical information were to be shared either directly or indirectly with current or future employers, insurers, and others.

Several types of solutions have been proposed that are designed to try to ensure patient anonymity or provide patients with some level of control over who may get access to their personal medical information. U.S. Pat. No. 6,732,113 to Ober et al. (2004) discloses a method of creating a central database to store medical information along with a complex method of creating unique aliases associated with each individual using a second data store. In the field of genetic testing, U.S. Pat. No. 7,089,498 to Rathjen et al. (2006) discloses a method for electronically storing the genetic information of individuals in a central database and providing individuals who submitted their genetic material for testing the ability to view their genetic information via a network connection after authentication of the data requester's identity as the original data owner.

U.S. Pat. No. 6,988,075 to Hacker (2006) discloses a system of centrally storing patients' medical records electronically and giving patients the ability to access their medical records online and further proposes giving patients the ability to authorize others to access or download their medical records or certain portions of it. Similar to Hacker, but specific to genomic data, U.S. Pat. No. 6,640,211 to Holden (2003) discloses a genetic banking system where the genomic data of individuals is stored on a central database and gives individuals the ability to authorize and pre-authorize selected trusted third parties to have access to their private genetic information and to also authorize and pre-authorize tests to be performed by the banking facility on behalf of third parties.

These methods differ significantly from the currently described invention because third parties are never given access to the private data. They are only given access to anonymous test results. Significantly, the currently described method does not authorize third parties to perform tests using the personal information. Instead, individuals perform all tests on their own computers and only share test results if they choose to do so. While the previously proposed methods try to achieve the same goals of offering patient privacy and patient control over access to private data, the previous methods share a number of disadvantages including the following:
a) The proposed solutions have the significant limitation of using a central database to store the data. Despite passwords and other controls created to limit what data is shared and with whom, patients remain unable to maintain and keep physical control over their medical and genomic data and thus need to rely on system administrators, policies, and other methods not under their direct control in order to protect the security of their data and maintain the privacy of their identity.
b) Centrally stored databases that provide internet access to others so that they can view, edit, copy, or conduct research with the data have the inherit problem of a single source of failure. If security is breached at the central database, or among the personnel maintaining the central database, as has happened for example with databases utilized for storing credit card information, then everyone who had their data stored centrally is vulnerable.
c) Another significant drawback is that no matter how trusted the third party, whenever individuals provide these third parties with access to their personal genetic and medical information, they are leaving themselves potentially vulnerable to the third party or its employees possibly making a copy of their personal data, sharing their data without the patient's consent, selling the data, misplacing the data, and suffering some other security breach.
d) An additional limitation is the high cost of building, maintaining, and securing a large central database to store the medical information of individuals. These costs become substantial when thousands or even millions of individual patient medical records are attempted to be stored centrally.

While technology has been developed and proposed to provide the capability of storing medical information using portable means or portable devices, their utilization has been uneven and their designs have had significant limitations largely due to the fact that they were never originally designed for use in private disease diagnosis or for conducting research. Originally, the first portable medical information storage devices were solutions such as military dog-tags or bracelets used by individuals that indicate that the wearer has a specific medical condition or allergy. U.S. Pat. No. 6,747,561 to Reeves (2004) discloses a device worn on the body, preferably in the form of jewelry, a medallion or watch that stores an individual's medical history. Reeves' proposed solution is primarily focused on offering an improvement over the original dog-tag concept. Other similar solutions have been proposed (Eberhardt U.S. Pat. No. 5,659,741 and Whalen U.S. Pat. No. 5,197,763). Both utilize credit card sized medical cards designed to be kept by individuals in their wallets or on their person. The primary purpose of these previously proposed solutions is to provide critical medical information in the case of a medical emergency; for example, when the wearer is unconscious or otherwise unable to provide critical information when emergency medical treatment is required.

Although the previously proposed solutions share the concept of portable storage of personal medical information, they fail to teach the invention herein described of providing a secure way for individuals to conduct private genetic testing, running queries against medical data stored on portable storage devices, or describe how individuals can securely share query results over a peer-to-peer network. Reeves mentions that his proposed device could be linked via the Internet to a central website or database, but only for the purposes of augmenting the storage capacity of the portable device or for providing international access to a person's medical record information. All of the cited prior portable storage methods suffer critical privacy and security disadvantages because their primary focus is on trying to provide a solution to the medical emergency problem. Some of the specific disadvantages include:
a) The security and privacy limitation of being designed for simple and easy identification and discovery by emergency workers and others. Unconscious patients or individuals who might misplace these types of portable devices would be particularly vulnerable that the privacy of their medical or genomic information could be compromised.
b) The security and privacy limitations raised by being designed for easy access and retrieval of the patient's private medical information. Such systems are by design intended to be used so that no consent or private personal password created or controlled by the unconscious patient is required in order to retrieve the medical information.
c) An additional shortcoming is that the previously proposed solutions provide for the transmission of personal medical information from the device to a caregiver over a network, the Internet or, as proposed by Reeves, over a wireless connection. Security could be breached while the medical data is being transmitted from the device over a network and could also be breached at any time after the data has been transmitted to and stored at the recipient's location.
d) An additional drawback of previously proposed portable electronic medical data storage solutions is the proposed functionality of having the device or system triggering the transmission of additional supplemental personal medical information to emergency medical workers and others from a central database. Proposals that provide for data transmission have the inherit weakness of having multiple sources of failure. Security could be breached while the medical data is being transmitted, by having a breach at the central data storage location, or by having a breach at the recipient's data storage system or location.

### BRIEF SUMMARY OF THE INVENTION

The invention disclosed describes a novel new method, system, and approach for conducting private disease diagnosis and conducting research. The method includes the storage of private genetic and medical information on portable digital storage devices to store personal genomic and medical information, allowing individuals to download and run queries privately against their genomic information, and enabling individuals to participate in researcher initiated queries over a peer-to-peer network.

It is an object of this invention to provide individuals with greater control over their personal genomic and medical information. The method provides individuals with access to genetic queries that they can download and run by themselves in private, and it facilitates the sharing of research queries and query results between researchers and individuals, while allowing each individual to maintain control over their personal data and choice in deciding whether to participate in queries. The features, utilities and advantages of the various embodiments of the invention will be apparent from the following more particular description of embodiments of the invention as illustrated in the accompanying drawings.

### BRIEF DESCRIPTION OF THE DRAWINGS

In the drawings, each step of the proposed apparatus, systems, and methods are shown. FIGS. 1 through 5 illustrate the embodiment of the invention in which the “personal query method” is utilized whereby individuals privately run their personal genomic data against a downloaded query.

FIG. 1 shows an individual providing their medical information and a blood, saliva, hair, or tissue sample for sequencing and receiving their sequenced DNA and medical information digitally stored on a portable storage device, such as a USB card.

FIG. 2 shows a central server that contains a list of queries (tests) that individuals can download on to their computer.

FIG. 3 shows an individual connecting to the central server via the internet and downloading genetic queries onto their computer

FIG. 4 shows an individual disconnecting their computer's network connection and inserting a USB storage device that contains their genetic information.

FIG. 5 shows an individual running the downloaded query against their own genetic information.

FIGS. 6 through 12 illustrate the embodiment of the invention in which the “peer-to-peer researcher query method” is utilized, in which researchers submit queries to the network, and individual network members who choose to participate can then download and run queries against their own personal data and submit the results anonymously back to the researcher.

FIG. 6 shows both a researcher and individual joining the peer-to-peer genomic network.

FIG. 7 shows a researcher creating a research query and submitting it to the peer-to-peer genomic network.

FIG. 8 shows an individual network member deciding whether or not to participate in the researcher's query.

FIG. 9 shows a network member who choose to participate, downloading the researcher's query, disconnecting their computer's network connection, inserting their USB storage device and running the query against their personal data.

FIG. 10 shows a network member who has completed running the researcher's query, disconnected their USB storage device, and reconnected their network connection.

FIG. 11 shows the participating network member submitting their query results to the peer-to-peer network, which forwards the data via aggregating nodes.

FIG. 12 shows aggregating nodes forwarding aggregated query results back to the researcher who initiated the query.

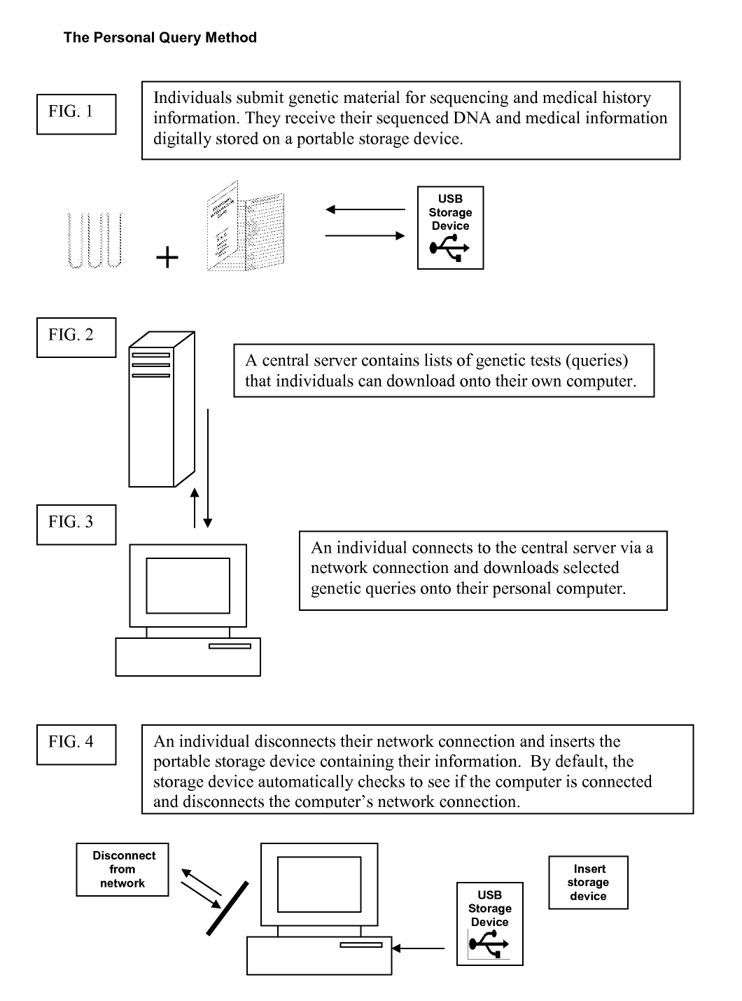

### DETAILED DESCRIPTION—FIGS. 1 THROUGH 5—FIRST EMBODIMENT

The present invention is a modular system that utilizes several core components in an integrated fashion. This invention disclosed herein provides for two improved methods to utilize personal genomic and electronic medical data while enhancing security and ensuring the privacy of each individual's genomic and medical information.

The first significant embodiment is that individual patients can use their own genetic information to run private queries in order to find out whether they have inherited specific genomic profiles that are known to cause, correspond to, or forecast the development specific diseases. Each individual person can then decide for themselves how they want to use the information and whether they want to share the information. For example, a person who has inherited a genomic profile that makes them especially susceptible to heart disease may want take early preventative actions through lifestyle modification and/or early pharmaceutical and/or other medical intervention in order to delay its onset or avoid getting the disease entirely.

The first embodiment is the “personal query method” as illustrated in FIGS. 1 through 5. The personal query method utilizes a portable storage device for storing an individual's genomic information and medical record. As shown in FIG. 1, an individual provides a sample of their genetic material, such as blood, for genomic sequencing and may also provide their medical history for inclusion. They then receive their digitized genetic and medical information stored on a portable storage device, such as a USB card or removable USB drive (such as an iPod device). As shown in FIG. 2, in addition to their genomic information, an individual will receive a URL with instructions to a central repository of genetic tests and queries providing: (a) a proxy server address, (b) user logon information, (c) lists of genetic tests or queries to be accessed, and (d) a URL link to download any genetic test in response to said configuration information and query request.

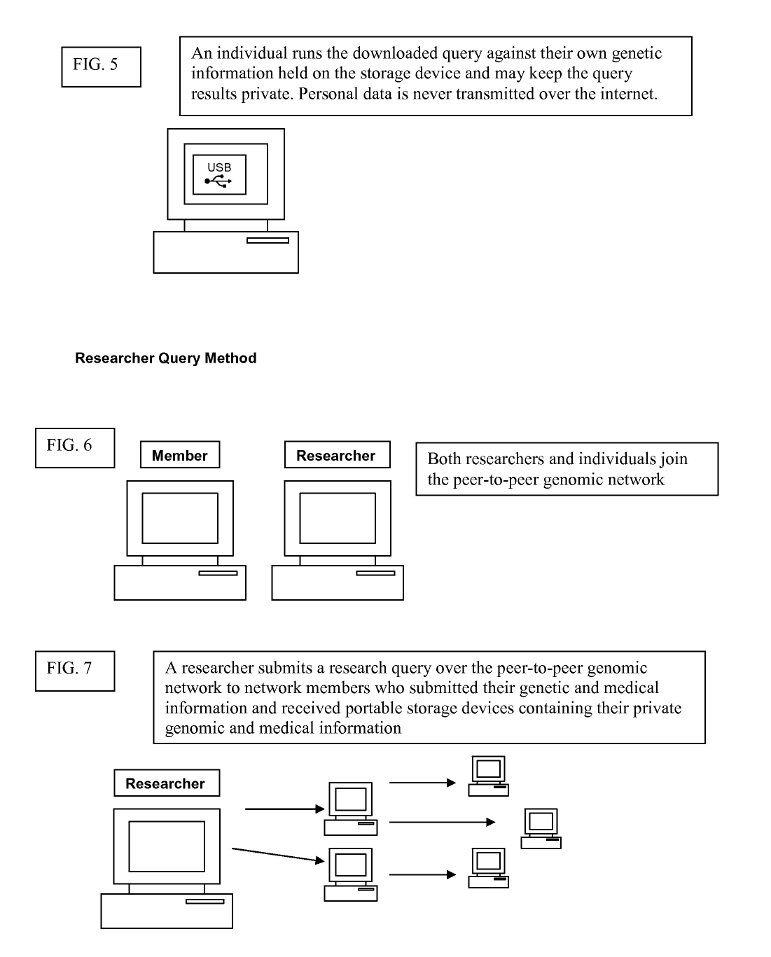

The repository of genetic queries is accessed by generating a URL link with its address and fields containing the information identifying the content portion and the genetic test. The generated URL link is communicated to an application used for identifying a test and downloading the test. As shown in FIG. 3, in order to perform a personal query and analysis, a patient must download at least one genetic test onto their personal computer (or other computational device) “computer” that is able to access a network. As shown in FIG. 4, once the query is downloaded, they can disconnect from the network and insert the storage unit containing their genetic information. As shown in FIG. 5, they then privately run the downloaded query against their own data.

The specific improvements offered and problems addressed by this method are that the personal genomic and medical information never needs to be sent over the network and does not need to be stored at a central location, database, or server. With the personal query method, only the genetic queries are located at a central location. It is only the tests that are downloaded to each individual's computer, in order to perform and run the query against the genetic data held on the portable storage unit or computer. The actual personal genetic and medical information always remain on each individual's portable storage unit or personal computer.

### FIGS. 6 Through 12—Additional Embodiment

An additional significant embodiment that can be assembled by using the components of this method is the creation of online search engine for use by genetic researchers and others. This additional embodiment utilizes the “peer-to-peer researcher query method”. In addition to individuals downloading tests and performing personal queries based on their own genomic data, another valuable component of this infrastructure and method is the ability to run queries against this data which can be aggregated for research and other purposes.

In the peer-to-peer researcher query method, when each individual receives their portable genomic and medical record storage device, they will also receive imbedded software that will to enable them to join and participate in the peer-to-peer genomic network. As membership to the genomic peer-to-peer network grows, and as individual network members become more comfortable with participating in queries, sharing query results, or agree to automate their participation, the network can perform the function of and become an online search engine for the human genome.

As shown in FIG. 6, both researchers and individual participants are provided software that allows them to join the peer-to-peer genomic network. Researchers must join the peer-to-peer network in order to submit queries to the regular network members. Regular network members are made up of individuals who joined the network after receiving their own portable storage devices following submission of their genetic material and medical information. Each individual patient network member will be provided with options during installation of their personal genomic record asking them whether they want to participate in queries, from whom they will accept query requests, for which purposes, and for which diseases. A person for example can configure their peer-to-peer genomic network participation to accept all queries, or only queries about pancreatic cancer, or queries only from a specific university, institution or group of institutions.

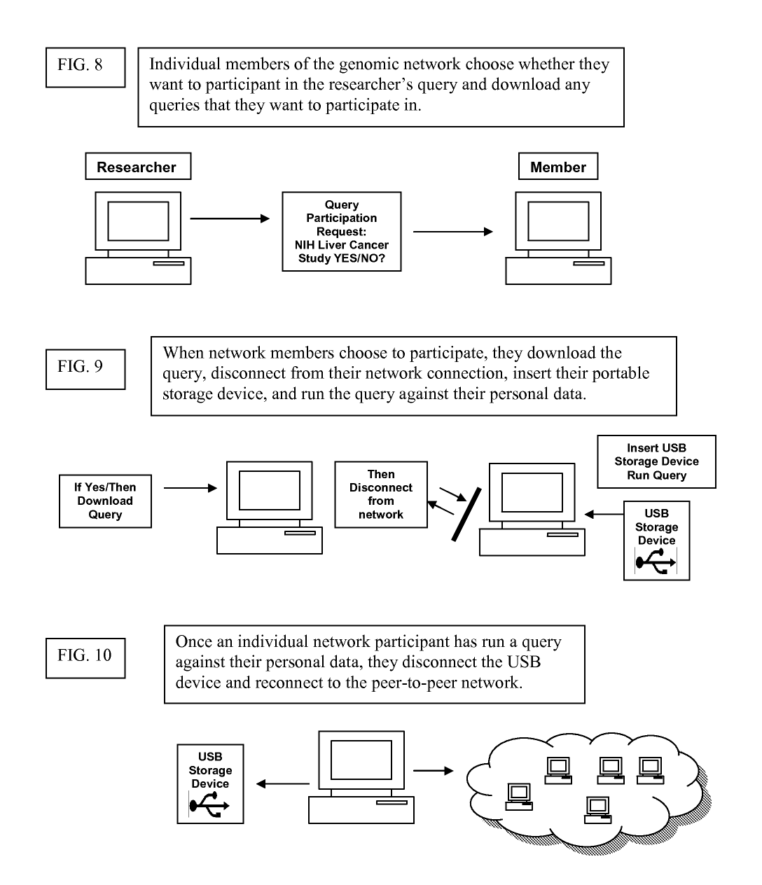

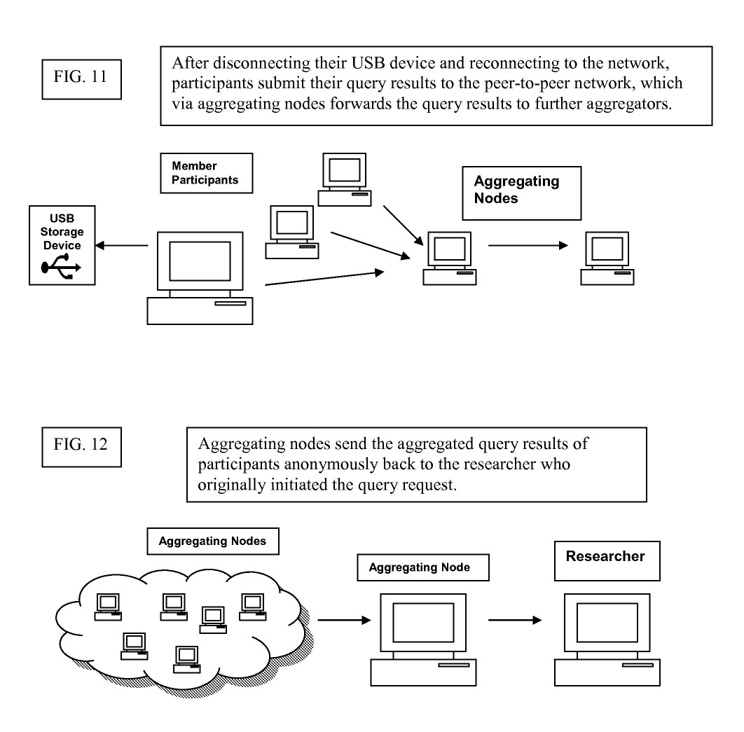

As shown in FIG. 7, in the peer-to-peer researcher query method; a researcher creates a research query and submits their credentials and query to the peer-to-peer network. As shown in FIG. 8, individual members of the genomic network then choose whether or not they want to participant in the researcher's query. As shown in FIG. 9, if they choose to participate, they download the query onto their own computer, can disconnect from their network connection, insert their USB storage device, and run the query against their personal data. As shown in FIG. 10, once an individual network participant has run a query against their personal data, they can disconnect their portable storage device, thus removing their personal data from their computer, and reconnect to the network. As shown on FIG. 11, After disconnecting their USB device and reconnecting to the network, participants submit the query results back to the peer-to-peer network, which via aggregating nodes forwards the query results to further aggregators. As shown on FIG. 12, the aggregating nodes send the aggregated query results of participants anonymously back to the researcher who originally initiated the query request.

As shown, the peer-to-peer query method initially defaults at the highest level of security. The highest level requires that the data storage device and network are never connected to a computer simultaneously. However, network participants are provided the ability to adjust their security settings lower, so that both the data storage device and network connection can be simultaneously connected to their computer and to even automate their participation. Security of personal data is enhanced by providing an imbedded software algorithm in the portable storage device that when connected to a computer, by default automatically checks to see whether the computer is connected to a network. At its highest setting, if a network connection is detected, it prompts the user to disconnect their network connection. It also provides the additional security steps of disconnecting the network connection if the user disregards the automated prompt, and also locks the data stored in the storage unit until the network connection is disconnected.

This novel method allows research to be performed while maintaining the privacy of each individual. In the decentralized peer-to-peer network, all peers act as equals, merging the roles of clients and server. Peers are responsible for hosting available resources and for making their shareable resources available to peers who request it. This method results in and maintains the capability of enhancing security and privacy by having the unique capacity of running queries even while the private genetic and medical information remains disconnected from the network.

Using this method, a researcher can create a query to be run against a specific population of members and to also run a query against control populations. For example, a researcher may want to find out if a particular gene contributes to obesity. The researcher would formulate a query looking for the presence of the specific suspect gene in a cohort of network members above a certain height/weight ratio. The height and weight information is stored on the portable storage unit, collected from medical records or via health information questionnaires submitted by clients when they submit their genetic material for sequencing. Individuals who agreed to participate in the obesity query would download and run the query on their own computers with the results merely answering whether they fit the search criteria and whether the gene was present or not. The query results would be aggregated over the peer-to-peer network and the researcher would receive the summary data from both the cohort of obese participants and the non-obese control group. An example of a successful query outcome would be having the researcher receiving aggregate data showing that 80% of the obese population, made up of 9,000 individuals, had the specific genomic profile that the researcher was looking for, while 90% of non-obese individuals, who numbered 15,000 participants, did not carry the genetic profile.

Because the invention described herein was designed from the start to give individuals greater control, including physical control, over their personal genomic and medical data and to provide a secure way to run private queries and share query results, it has many improvements and innovations over prior art which, in part, include:
a) It provides for enhanced security in the acquisition and storage of genetic medical information. Each person retains physical control of their own data and no personal genomic or medical data needs to be stored centrally. The method includes having individuals submit genetic material for genomic sequencing, and filling out a health questionnaire, providing their medical record, and/or providing a completed medical record release form, so that their medical information can be integrated with their genomic data. In return patients receive a portable storage device, such as a USB storage device, or any large digital storage medium such as a computer chip, flash memory stick or other digital storage medium containing their sequenced genetic information combined and integrated with their personal medical information.
b) It provides a secure way for individuals to perform queries by letting individuals download genetic tests and privately running queries against their own genomic data. The method includes connecting to a server, downloading queries, disconnecting the network connection, and running the downloaded queries against their private data. No private genomic data needs to be transmitted over the internet, submitted to someone else for testing, stored centrally, and individual's can keep query results completely private.
c) It provides a secure procedure for researchers to run queries against individuals who have indicated a willingness to participate in and respond to research queries over a peer-to-peer network. The method includes researchers and individuals joining the peer-to-peer genomic network, researcher's submitting their queries to the network, and individual's anonymously downloading the queries they want to participate in and anonymously submitting only the query results back to the researcher over the peer-to-peer network.
d) It provides additional steps to improve the security of personal data by providing levels of security with the highest level utilizing an imbedded software algorithm in the portable storage device that when connected to a computer, automatically checks whether the computer is connected to a network. If there is a network connection, it prompts the user to disconnect their network connection. It also provides the additional security steps of disconnecting the network connection if the user disregards the automated prompt, and also locks the data in the storage unit until the network connection is disconnected.
e) It provides enhanced data security because even if the portable storage device was discovered by an unauthorized user, the storage device would contain an algorithm requiring user authentication including knowledge of the individual user's username and password in order to access the data on the device.
f) It provides for enhanced security in the analysis of genetic information so analysis can be performed even while the computer is completely disconnected from a network.
g) It permits enhanced data security because query results can be encrypted when sent over the peer-to-peer network.
h) It allows for constant upgrading and addition of improved and new genetic algorithms that can be downloaded, and run, as new discoveries are made and published.
i) It provides for a more cost effective means to store personal medical and genomic data versus the traditional method of creating and maintaining a large central database.
j) It provides for a more cost effective means to performing genetic testing because a sample of genetic material only needs to be taken once and all subsequent tests are performed against the digitized information.
k) It provides for the creation of online genetic search engine allowing for the submission and running of genetic queries that can lead to important discoveries on the causes of disease and lead to significant cures.

1-16. (canceled)

17. A method for utilizing digitized personal genomic data not stored on a centralized server, the method comprising:
(a) providing a query on a network-accessible computer that permits individuals possessing their digitized personal genomic data to download the query from the network-accessible computer,
wherein the query, if downloaded by an individual onto a personal computer or other computational device, can be run against the individual's own digitized personal genomic data to conduct a genetic analysis of the individual's own digitized personal genomic data.

18. A method for utilizing digitized personal genomic data not stored on a centralized server, the method comprising:
(a) providing a query on a network-accessible computer that permits individuals possessing their digitized personal genomic data to download the query from the network-accessible computer, wherein the query, if downloaded by an individual onto a personal computer or other computational device, can be run against the individual's own digitized personal genomic data to conduct a genetic analysis of the individual's own digitized personal genomic data; and
(b) receiving aggregate information from results of running the query on the digitized personal genomic data from individuals agreeing to participate in the query.

19. The method of claim 18, wherein the aggregate information is received from aggregating nodes.

20. The method of claim 17, wherein the network-accessible computer is a centralized server.

21. The method of claim 17, wherein the individuals also possess their digitized medical information and the query can be run against the individual's own digitized personal genomic data and their digitized medical information.

22. A method for individuals to perform an analysis of their own digitized personal genomic data not stored on a centralized server, the method comprising:
(a) downloading a query from a network-accessible computer onto a personal computer or other computational device; and
(b) running the downloaded query on the individual's own digitized personal genomic data that are not stored on a centralized server to conduct a genetic analysis of the individual's own digitized personal genomic data.

23. The method of claim 22, wherein the network-accessible computer is a centralized server.

24. The method of claim 22, wherein, during step (b), the downloaded query is run after the personal computer or other computational device has been disconnected from the network connecting the network-accessible computer and the personal computer or other computational device.

25. The method of claim 22, wherein the digitized personal genomic data are stored on a portable storage device.

26. The method of claim 25, wherein a medical record of the individual is also stored on the portable storage device and, during step (b), the downloaded query is run on the individual's own digitized personal genomic data and on the medical record.

27. The method of claim 25 further comprising the step of, prior to step (b), connecting the portable storage device to the personal computer or other computational device.

28. The method of claim 22 further comprising the step of, after step (b), transmitting the results of the downloaded query.

29. The method of claim 28 further comprising the step of disconnecting the portable storage device before transmitting the results of the downloaded query.

30. The method of claim 28, wherein the results of the downloaded query are transmitted to a centralized server.

31. The method of claim 28, wherein the results of the downloaded query are transmitted to an aggregating node.

32. The method of claim 31, wherein the results are transmitted on a peer-to-peer network.

33. A portable storage device comprising:
digitized personal genomic data; and
software that, when the portable storage device is connected to a computer, checks to see whether the computer is connected to a network.

34. The portable storage device of claim 33, further comprising:
medical information of the person whose digitized personal genomic data are stored on the portable storage device.

35. The portable storage device of claim 33, wherein the software prompts a user to disconnect a detected network connection.

36. The portable storage device of claim 33, wherein the software disconnects a detected network connection.

37. The portable storage device of claim 33, wherein the software locks the digitized personal genomic data if a network connection is detected.
